(19) United States
(12) Patent Application Publication
(10) Pub. No.: US 2011/0307284 A1
(43) Pub. Date: Dec. 15, 2011

(54) COMMAND CENTER COMMUNICATION SYSTEM FOR IMPROVED MANAGEMENT OF COMPLEX MEDICAL ENVIRONMENTS

(75) Inventors: Paul R. THOMPSON, White Bear Lake, MN (US); Chun Shi, Blaine, MN (US); William Charles Ballough Harding, Chandler, AZ (US); Timothy Douglas Paffel, Shafer, MN (US)

(73) Assignee: MEDTRONIC, INC., Minneapolis, MN (US)

(21) Appl. No.: 13/156,858

(22) Filed: Jun. 9, 2011

Related U.S. Application Data
(60) Provisional application No. 61/353,028, filed on Jun. 9, 2010.
(60) Provisional application No. 61/397,417, filed on Jun. 11, 2010.

(51) Int. Cl. G06Q 10/00

(52) U.S. Cl. 705/7.13

(57) ABSTRACT

Computer-implemented systems, apparatus and methods for managing information, operations and functions in a complex medical environment and providing a command control center interface for receiving/sending/displaying data, relating to products, instructions, diagnosis, consultation, patient's information, supplies and their provision, registration, scheduling, updating and like operational functions and features, and updating on an ongoing basis to coordinate, control and synchronize necessary and/or desirable operations within the environment, whereby the “hospital of the future” is effectively facilitated with proficiency and efficiency in an accurate and reliable manner. Such systems may also include one or more client terminal devices in communication with a data interchange subsystem.

### CROSS REFERENCE TO RELATED APPLICATIONS

This application claims priority to U.S. Provisional Patent Application Ser. No. 61/353,028, filed on Jun. 9, 2010 and U.S. Provisional Patent Application Ser. No. 61/397,417, filed Jun. 11, 2010, the entire contents of each of which are incorporated herein by reference. This application is related to U.S. patent application Ser. No. ______, filed Jun. 9, 2011 (Attorney Docket No. 059022-0395152), which claims priority to U.S. Provisional Patent Application Ser. No. 61/353,028, filed on Jun. 9, 2010 and U.S. Provisional Patent Application Ser. No. 61/397,417, filed Jun. 11, 2010, the entire contents of each of which are incorporated herein by reference.

### FIELD OF THE INVENTION

This invention relates to a system for managing hospital data, procedures, patients, supplies and the like.

### BACKGROUND

The daily functioning of modern hospitals, clinics, and similar environments often require the performance of many management tasks. The tasks must often track patients, monitor sophisticated medical instruments and other medical devices, manage the staffing and scheduling of hospital procedures, maintain hospital inventory, and track medical data. The number of tasks continue to grow with the evolution of science and increasing patient hospital occupancy.

Many of the management tasks have previously been manually implemented. For example, nurses may have manually filled out charts and manually filed them to track a patient's medical data. Physicians may have manually reserved facilities for hospital procedures and may have coordinated with other hospital staff on an ad hoc basis. Hospital administrators may have manually checked and updated the inventory levels of hospital supplies.

With the advent of digital electronics and computers, some computerized subsystems have been used to assist individual management tasks. Although the computerized subsystems may perform some tasks in an automated manner, hospital management using the subsystems may require multiple systems that may store redundant data, require duplicitous data entry, and require acclimation with multiple system interfaces. Thus, a better way for managing hospital equipment, supplies, patients, procedures, and other operations is desired.

### SUMMARY OF THE INVENTION

Apparatus, systems, and methods are disclosed for performing a plurality of management tasks in a hospital, clinic, medical center, or other medical environment. The management tasks may include managing hospital data, procedures, patients, inventory, and other hospital- or medical-related functions. A hospital command center is provided that may provide a central interface for hospital personnel to perform the management tasks, to monitor and coordinate various operations in the hospital or medical environment, and to facilitate management for a “hospital of the future.”

According to an embodiment, the command center may provide a centralized interface to view patient vitals, manage hospital inventory, schedule procedures, consult with other physicians, exchange information with medical device manufacturers, view multimedia presentations, view e-mails and other messages, receive news feeds, weather updates, and to manage other hospital operations in a complex medical environment. The centralized interface may allow physicians, nurses, technicians, administrators, and other hospital staff to view and coordinate among many different hospital operations. For example, hospital staff scheduling a surgery may be able to obtain information on the availability of hospital facilities, the availability of hospital staff, the status and reservations on hospital equipment needed for the procedure, the amount of various supplies remaining in the hospital inventory, and information about the patient. All such information may be presented through the centralized interface. The centralized interface may eliminate the redundancy in consulting and cross referencing separate records or databases for facility reservations, staff schedules, inventory management, patient management, and other information records related to management of the medical environment. The centralized interface presented by the command center may therefore increase the efficiency and speed in managing hospital operations.

The centralized interface may also allow hospital staff to manage specific pieces of medical equipment or inventory by remotely configuring, activating, or deactivating the equipment. For example, a medical device may be configured to communicate with the digital command center and to receive commands and configuration data. The commands may allow the staff to manage many different medical devices through the digital command center. The command center may have a common protocol that is used by the different medical devices, or the command center may use device-specific protocols when communicating with a medical device. The medical device may be adapted to, for example, deactivate itself based on a command issued by the digital command center.

The centralized interface may be rendered by a computer system, such as a server or system of servers that are located on the physical premises of the hospital or located remotely. For example, a central cloud computing facility located away from the hospital may implement the digital command center and render the centralized interface at a terminal or other display device that is located on the hospital premises.

A point of use device, for example, may be used to display part or the entire centralized interface that a digital command center is capable of rendering. The point of use device may be portable and incorporate a display and other multimedia capabilities, allowing a physician and other hospital staff to view the centralized interface at their offices, labs, homes, and other locations.

According to one aspect of the invention, the digital command center may communicate with other medical equipment in the hospital to monitor the status of the equipment. According to another aspect of the invention, the command center may communicate with other databases, such as patient records databases, to synchronize its data with that of the databases. According to another aspect of the invention, the command center may communicate with inventory management devices to monitor the level of hospital supplies. According to another aspect of the invention, the command center may present news, messages, and educational materials to hospital staff and patients. A patient may use a point of use device, for example, to receive multimedia presentations related to general medical topics or to medical information specific to the patient.

The digital command center may facilitate workflow management related to device data exchange, patient distribution, and patient therapy. The command center may allow tracking the management of patient therapy and of patients, including viewing of procedures already performed and scheduled to be performed. It allows physicians to be presented with prescribed steps of therapies, such as tests, diagnostics, surgeries, follow-ups, physical therapy, administration of medicine, and other procedures. The command center may allow hospital staff to be notified if there are procedures within the workflow that are past due or incomplete. Data related to patients may be collected through nurses, patients, sensors, or other devices, such as RFID tags contained in patient wrist bands.

These and other aspects of the invention will become more readily apparent from the following detailed description of the invention and accompanying drawings and illustrations.

### BRIEF DESCRIPTION OF THE DRAWINGS

FIG. 1 is a block diagram illustrating the command center and its interaction with various hospital facilities and operations, in accordance with an embodiment of the invention.

FIG. 2A illustrates an example view that may be provided by the centralized interface of the command center, in accordance with an embodiment of the invention.

FIG. 2B illustrates an example view that may be provided by the centralized interface of the command center, in accordance with an embodiment of the invention.

FIG. 3 illustrates an example view that may be provided by the centralized interface of the command center, in accordance with an embodiment of the invention.

FIG. 4 illustrates an example view that may be provided by the centralized interface of the command center, in accordance with an embodiment of the invention.

FIG. 5 illustrates an example view that may be provided by the centralized interface of the command center, in accordance with an embodiment of the invention.

FIG. 6 illustrates an example view that may be provided by the centralized interface of the command center, in accordance with an embodiment of the invention.

FIG. 7 illustrates an example view that may be provided by the centralized interface of the command center, in accordance with an embodiment of the invention.

FIG. 8 illustrates a point of use device that may interact with the command center to perform various management tasks, in accordance with an embodiment of the invention.

FIG. 9 illustrates a data interchange system that may allow the command center to interact with a medical device manufacturer's backend system, in accordance with an embodiment of the invention.

FIG. 10 illustrates a medical device that may interact with the command center, in accordance with an embodiment of the invention.

### DESCRIPTION OF THE PREFERRED EMBODIMENT(S)

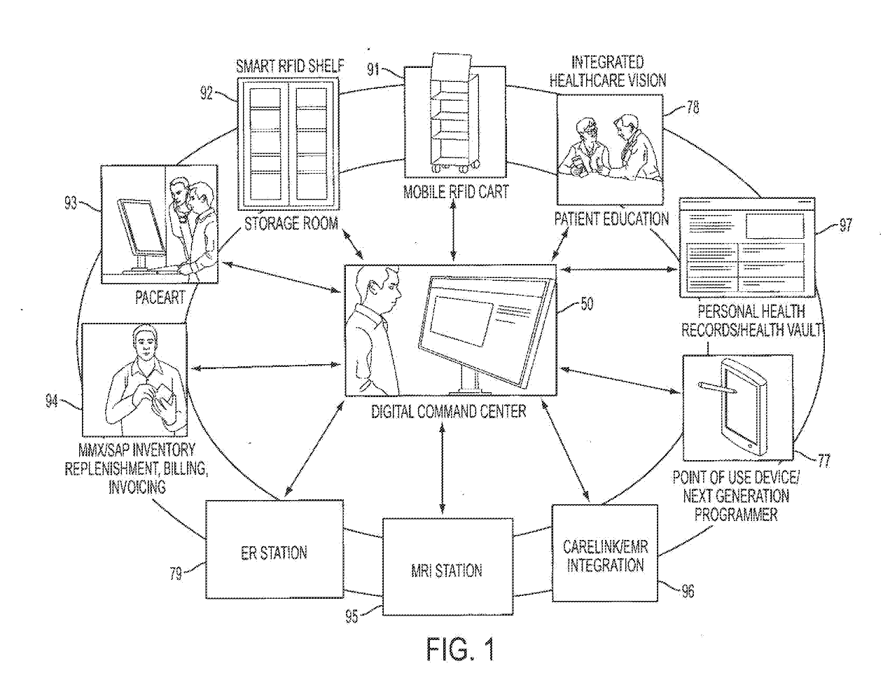

FIG. 1 illustrates a digital command center operating in a medical environment. The medical environment may include a hospital, clinic, physician's office, medical center or any other environment related to medical practice. The medical environment is not confined to a physical site, but may include a plurality of sites communicating with each other. For example, medical environment may include a hospital, medical equipment that is remote from the hospital and shared with another facility, and a data center remote from the hospital. The communication within a medical environment may be done through dedicated networks or a public network, such as the Internet.

Within the medical environment, a digital command center 50 interacts with various operations, equipment, and services that are used in managing the hospital. The digital command center may be implemented by any logic circuit, such as a computer, server, or system of servers. For example, in a medical environment that includes a hospital and a remote data center, the digital command center may be implemented across a plurality of servers located at the data center. The servers of the command center may communicate with databases, terminals, or equipment. If the digital command center 50 is hosted remotely, it may provide a display on the physical premises of the medical environment that communicates with the remote computers or servers through a network.

The digital command center may facilitate workflow management related to various hospital operations, such as device data exchange, patient distribution, and patient therapy. A physician may access through the command center a list of procedures already performed and scheduled to be performed. The command center may present prescribed steps and therapies, such as tests, diagnostics, surgeries, follow-ups, physical therapy, administration of medicine, and other procedures. The command center may allow hospital staff to be notified if there are procedures within the workflow that are past due or incomplete. Data related to patients may be collected through nurses, patients, sensors, or other devices, such as RFID tags contained in patient wrist bands.

The command center 50 may interact with a smart RFID shelf 92 that identifies medical devices and other products based on radio frequency tagging. For example, the RFID shelf 92 may be used to store a plurality of medical sensor devices, such as oximeters, heart rate monitors, and digital thermometers. The RFID shelf 92 may be used to store medical devices used in hospital procedures, such as pumps, defibrillators, aspirators, and other instruments. The RFID tags may be embedded in the medical devices, or may be attached to the devices. Medical devices may include one or more products and/or devices which are intended for use by patients and/or health care providers. For example, medical device may be used for various purposes, such as, in diagnosis, monitoring, therapy, treatment, or surgery. Some devices may be used externally, internally, or both by the patient (generally as the nature of a particular medical device may dictate). Exemplary medical device may include, but are not limited to: pacemakers, stents, coronary grafts, defibrillators (implantable or external), drug pumps, artificial valves, replacement joints, monitors, neurostimulators, prosthetics, etc. Some medical devices may be regulated by the Food and Drug Administration (FDA), and/or other government agencies. Others, though, may not.

Depending on the medical device 110 and treatment, the medical device 110 may have to be used, implanted, installed, configured, removed (explanted), etc. by the health care provider 130, at a clinical site 140.

The RFID shelf 92 may track inventory that is available in the medical environment and communicate the inventory levels to the digital command center via wired or wireless communications. For wireless communication, one or more of antennas may be provided for transmitting and receiving electromagnetic energy wirelessly. Alternatively or additionally, optical transmission may also be used, including, for instance, an infrared (IR) communicator device (e.g., according to the IrDA specification). In some implementations, the network interface module 320 may be configured for WiFi (IEEE 802.11), WiMax (IEEE 802.16), cellular (e.g., 0G, 1G, 2G, 3G, 4G, etc.), standard telephony networks, and/or other wireless access technologies and standards. Various RFID tags contained within the RFID shelf 92 may communicate directly with a wireless receiver of the digital command center 50, or may communicate through an intermediary receiver. For example, if a wireless receiver of the digital command center is out of the range of an RFID tag, it may transmit to a local dedicated receiver or WiFi™ receiver that relays the transmission to the command center 50. For example, a local transceiver for relaying the information may be located on the shelf 92.

Devices on the RFID shelf 92 may be configured to track their usage, operational status, scheduled future use, and other information relevant to management of a medical environment. The information communicated to the command center 50 may then be displayed to hospital administrators and other staff. The command center 50 may allow administrators to view the status of individual pieces of medical devices on the shelf 92, or may allow administrators to view aggregate statistics, such as the total number of operational oximeters, the average use of the digital thermometers, or another management-related statistic. The command center 50 may communicate with one or a plurality of RFID shelves.

The command center 50 may interact, directly or indirectly, with a mobile RFID cart 91. The mobile RFID cart 91 may track the location of patients and equipment attached to the cart 91. For example, a cart 91 may be associated with and transport a medical device such as an ultrasound instrument. In another example, the cart 91 may be associated with heart monitoring instruments for a patient. The cart 91 may be used to track the status of the medical device associated with the cart 91 as well as other information, such as medical data generated by the medical device. For example, the cart 91 may communicate its location to the command center 50. The command center 50 may use the location information to identify the location of medical devices and patients associated with the cart 91. In another example, the cart 91 may communicate monitored heart rate data of a patient to the command center 50, which may display such data for physicians and other medical environment staff. The command center 50 may aggregate the information received from the RFID shelf 92 and RFID cart 91 to determine inventory levels in the medical environment or the operational status of specific medical devices.

Medical devices may also be scanned by the command center 50. Scanning the medical device may obtain one or more of the following medical device information elements: device name, and identification code thereof, model number, and serial number. In some instances, this may include capturing information directly from the device (or packaging) itself. In other instances, this may include reading a machine-readable indicia and retrieving stored information (e.g., from the medical device manufacturer) corresponding to the indicia. Patient information may also be retrieved from the device itself, or from a database of patient information matched to a device's serial number.

The command center 50 may interact with various management subsystems used by the medical environment. For example, the medical environment may use a separate inventory subsystem 94 that manages inventory, replenishment, billing, and invoicing of equipment and supplies for the medical equipment. The command center 50 may implement a specific protocol to communicate with the inventory subsystem 94, or may communicate via a protocol common for inventory subsystems. The command center 50 may use received information from the inventory subsystem 94 to update its own recorded inventory levels. If the command center 50 determines records in the inventory subsystem 94 to be outdated or incorrect, the command center 50 may communicate the updated or correct information to the inventory system 94. The command center 50 may also assist the inventory subsystem 94 in performing diagnostic functions of medical devices. For example, if an inventory subsystem 94 indicates that a medical device has been subject to continuous use, the command center 50 may issue a command to the medical device to perform a self-diagnostic test.

A medical device may implement commands from the command center 50 to perform management-related functions, such as perform a self-diagnostic test, report operational status, report usage history, change configuration settings, or activation or deactivation. For example, if the command center 50 determines from the inventory subsystem 94 data that a medical device has been used past its lifespan, it may issue a command for the medical device to deactivate. In another example, if the command center 50 determines that a medical device has been used continuously, it may issue a command to the medical device to reconfigure its activity levels so as to prolong the device's lifespan.

Medical devices may also communicate collected medical data to the command center 50. For example, a pacemaker may communicate its battery levels as well as heart rate information to the command center 50. A medical device may communicate medical data directly to the command center 50, such as through a wireless transmission directed to a receiver of the command center 50, or may communicate information indirectly to the command center 50. For example, the command center 50 may interact with medical databases or other subsystems that have collected or archived information from medical devices. FIG. 1 shows the command center 50 to interact with Paceart®, a system that collects and archives data collected from cardiac devices from a plurality of medical manufacturers, or with CareLink®, a program which connects cardiac device patients to their clinic from home or away.

The command center 50 may implement a protocol specific to each of the systems, or may use a common protocol. The command center 50 may receive information stored in the databases and may also update the databases with new medical data. The command center 50 may also interact with other collection and archival systems that collect medical data from other medical devices and sensors. The data may contain information about a patient using the medical device or about the medical device itself, such as a device identifier, battery level, the results of a diagnostic test, or other device-related information. The data accessed by the command center 50 in a database may include records stored in a personal health records database 97 or electronic medical records (EMR), such as those provided by CareLink®. The data received by the command center 50 may be presented to the physician as part of a centralized interface where a physician can view schedules of hospital procedures, patient involved in the procedures, medical data related to the patients, and availability of various medical devices involved in the procedures. The centralized interface illustrated in the embodiments is shown as a graphical user interface (GUI), but may also be a text-based or audio-based interface, or some combination of the formats.

The command center 50 may also facilitate interactions among the operations and services in the medical environment. For example, the command center 50 may register medical devices with the CareLink® or Paceart® systems with information that it collected. Enrollment in patient management service may require, for example, a patient name, device name (or corresponding code), device serial number, patient identifying information, healthcare provider identifying information, clinical site identifying information, date patient received the medical device, enrollment date, and/or other information. Such information may be provided by the command center 50.

The command center 50 may collect device identifier information, for example, from the RFID shelf 92 or RFID cart 91. The command center 50 may automatically submit the information to a service such as CareLink®, thus relieving hospital staff from having to manually enter such information. The command center 50 may also monitor medical devices by periodically querying the equipment for its operational status or commanding the equipment to perform a self-diagnostic test. If a medical device is determined to be malfunctioning or nearing the end of its lifespan, the command center 50 may issue an alert through the centralized interface. The command center 50 may also automatically order additional devices or supplies through a medical device supplier or medical device manufacturer.

FIG. 1 also shows the command center 50 directly interacting with facilities and equipment, such as an ER station 79 and MRI station 95 within the hospital environment. For example, data generated by medical equipment in the ER station 79 or MRI station 95 may be transmitted to the digital command center 50. The data may include measurements and other information related to a patient, and may include information related to the equipment, such as results of diagnostic tests or other information on the operational status of the equipment.

Also shown in FIG. 1 are other interfaces that the digital command center 50 may communicate with. For example, selected information stored by the command center 50 may be transmitted to a patient education interface 78. The patient education interface 78 may be accessed by a patient to view general medical knowledge, medical data specific to the patient, or other medical information related to patient education. The command center 50 may also interact with a point of use device 77. The point of use device may incorporate any terminal or interface, such as a laptop, computer, phone, tablet, or other interface that communicates with the command center 50. The device 77 may be used by physicians, nurses, administrators, technicians, other hospital staff, and patients to receive and present information from the digital command center 50. A physician, for example, may access information related to hospital scheduling from the digital command center, which may transmit the information to the terminal device 77, such as the physician's tablet computer. The physician may then view the hospital scheduling information on the tablet computer instead of a terminal located at the hospital or other medical environment.

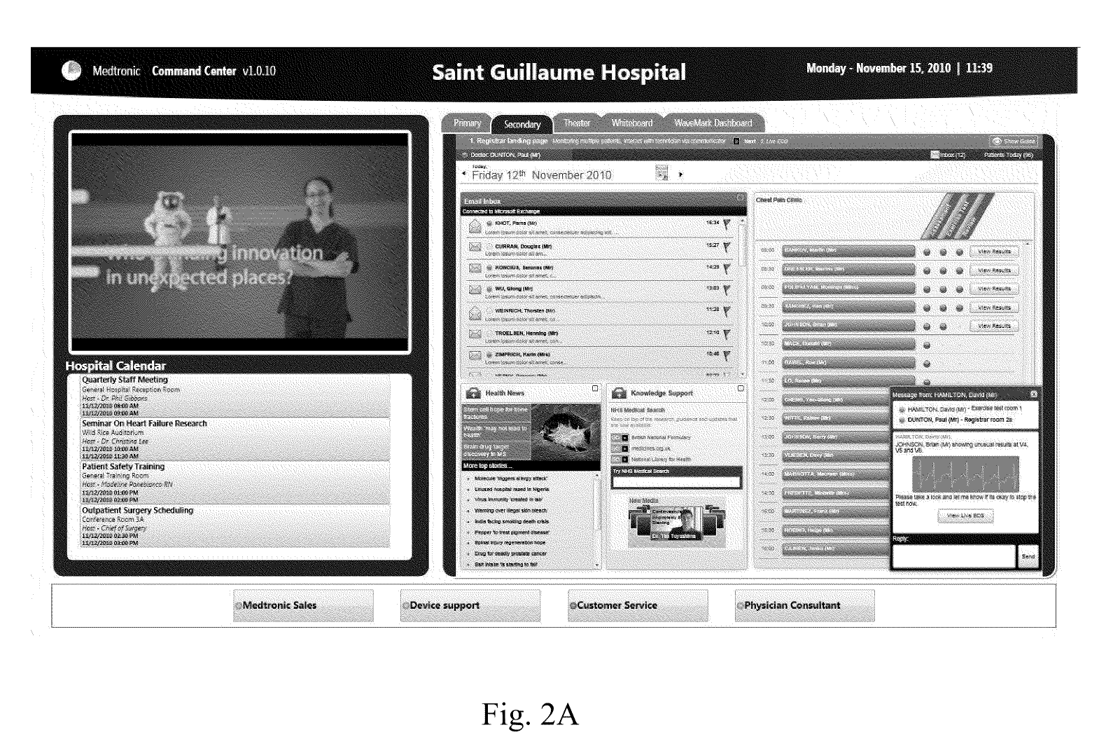

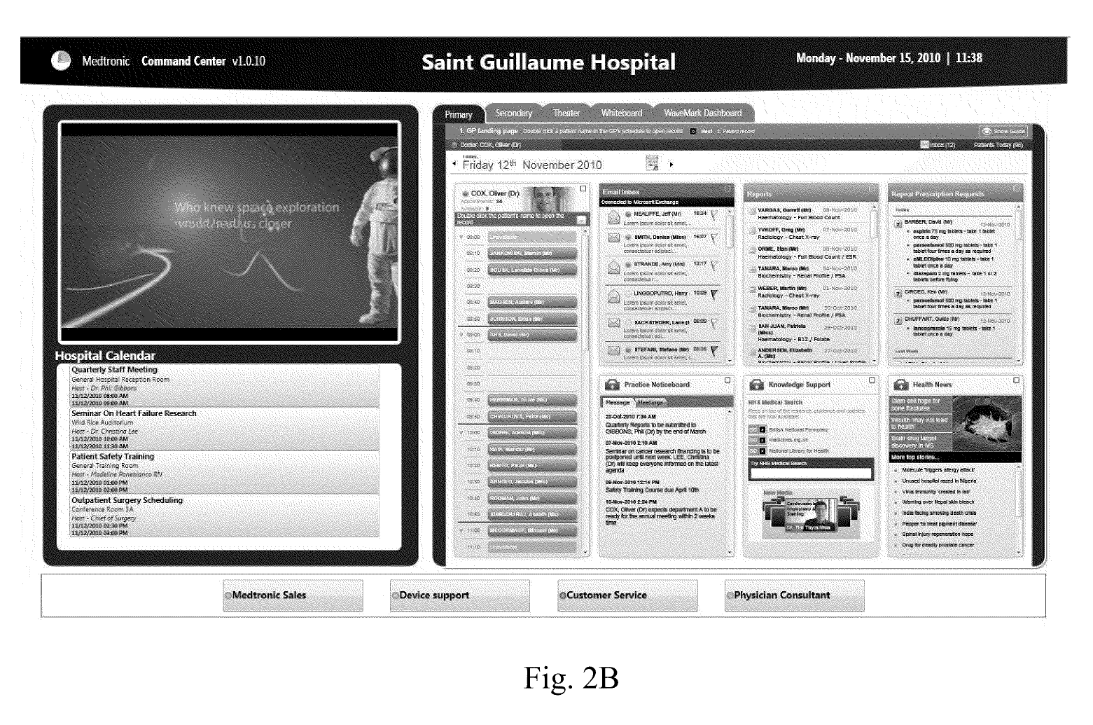

FIG. 2A illustrates an example view that may be presented by the command center 50 on a centralized interface. The centralized interface may be rendered on a designated terminal display in the hospital, rendered on the terminal device 77, on the patient education device 78, or some other display device. The centralized interface may allow a user to select the information that the command center 50 is to present on the display. The command center 50 may present a default set of information based on the identity and role of the user. For example, patient data and hospital procedure information may be presented to physicians, and inventory information may be presented to hospital administrators. FIG. 2 shows a centralized interface presenting general information that may be useful to all types of users. For example, a user's e-mail, hospital calendar or other calendar, and news feed may be presented to the user. The command center 50 may implement an e-mail system and a news and weather retrieval system. Alternatively, the command center 50 may retrieve the news and weather with other subsystems to obtain such data. For example, the command center 50 may interact with a separate e-mail program to present e-mails to the user. The command center 50 may rely on a separate news feed service to retrieve and present news headlines to the user. The general information, including e-mails, weather, and news headlines may be one of many customizable views available on the centralized interface. A user may be able to switch among different views dedicated to different types of hospital-related information. FIG. 2B shows a view that presents additional data, such as a compilation of reports. The reports may be generated based on various diagnostic tests that were run for patients. The view may also present prescription requests to allow users to view issued prescriptions, the associated patient and medication, and whether the prescription has been filled.

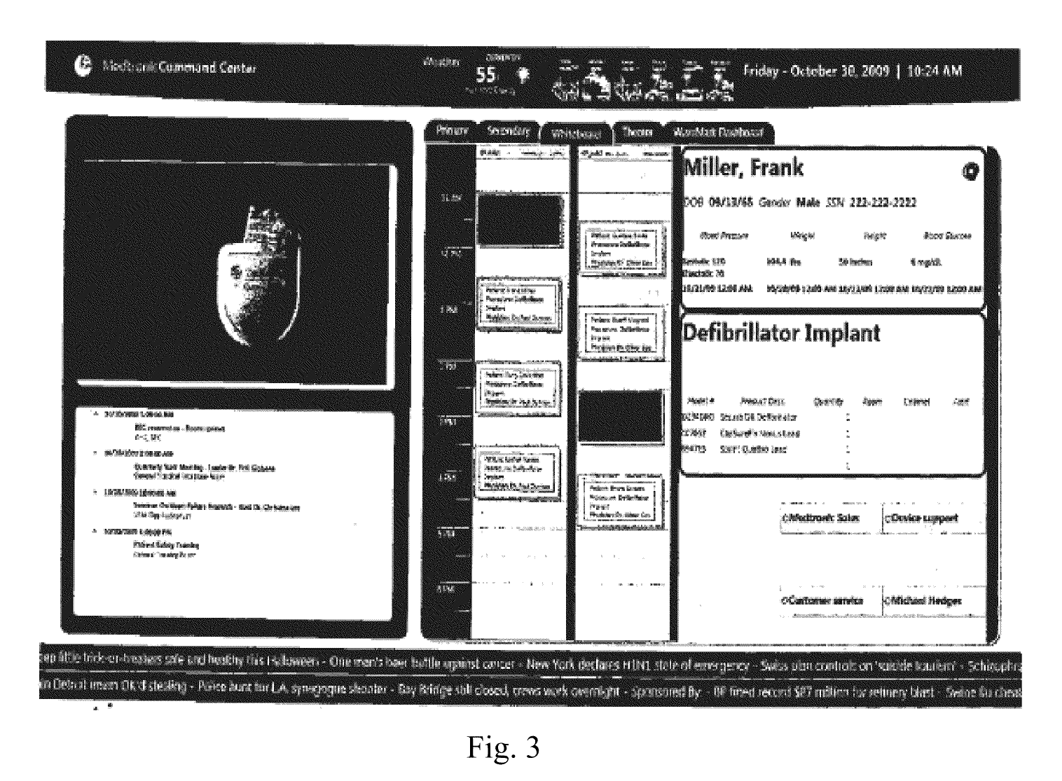

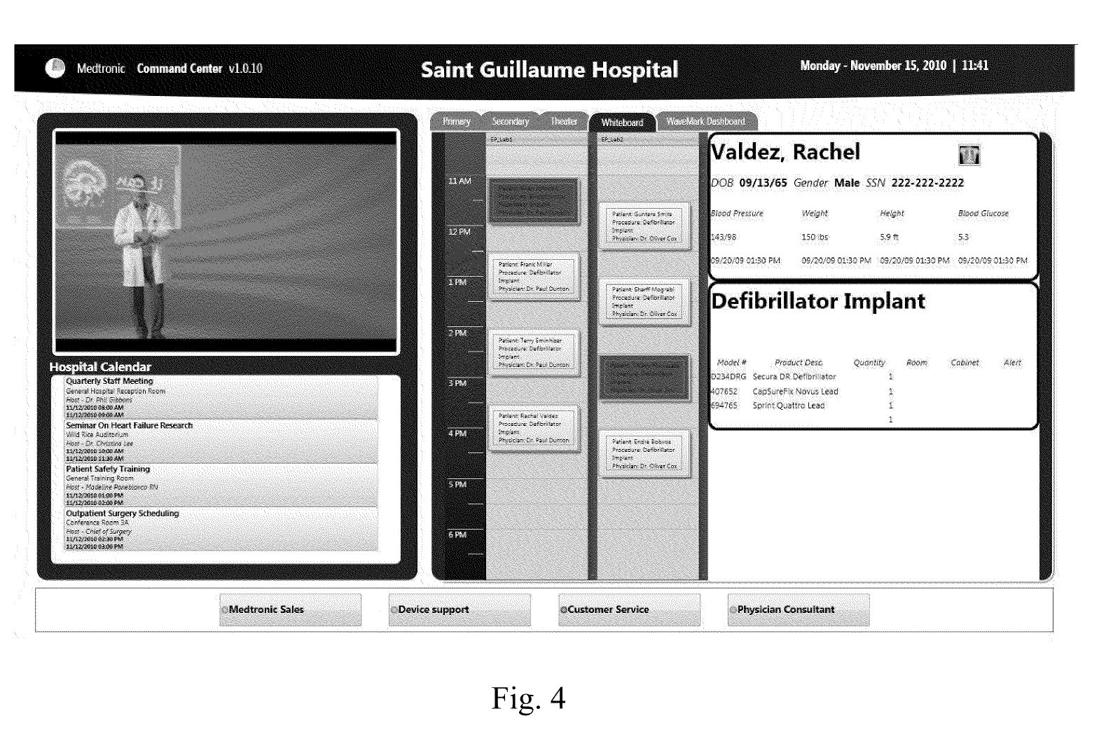

FIG. 3 shows a view that presents a virtual whiteboard to a user such as a physician. The virtual whiteboard allows a physician to view, for example, the physician's schedule. The schedule may include procedures that the physician is scheduled to perform. The centralized interface may also present a physician's personal schedule along with the physician's professional schedule. The schedule may be presented as a calendar to which the physician or other hospital staff can add, modify, or remove events. The centralized interface allows the physician to see the scheduled procedure, patient information, and medical device information at the same time. The physician may be presented with the age, gender, and other information of the patient, the model and picture of the medical device to be used in the procedure, and an option to contact customer support offered by the medical device manufacturer. The availability of hospital facilities, such as operating rooms, may also be presented. The centralized interface may also allow a facility to be reserved. The centralized interface may also present the schedule of other hospital staff during the times of a physician's scheduled procedures. A physician may use the centralized interface to view the availability of other physicians, nurses, and personnel for a particular procedure. The centralized view may reduce the need to consult separate subsystems and interfaces for scheduling, patient data, and manufacturer support. Another set of patient and procedure data is shown in FIG. 4. The interface may improve operational efficiency, patient safety and clinical outcomes at a hospital device implant lab, for example, by integrating implant schedule, inventory, device data, and patient data with video conferencing to key support personnel at desired locations. The physician may be allowed to click on or touch the individual windows to obtain more information. For example, the centralized interface may allow the physician to click on the patient data box to open a separate window displaying more comprehensive patient data.

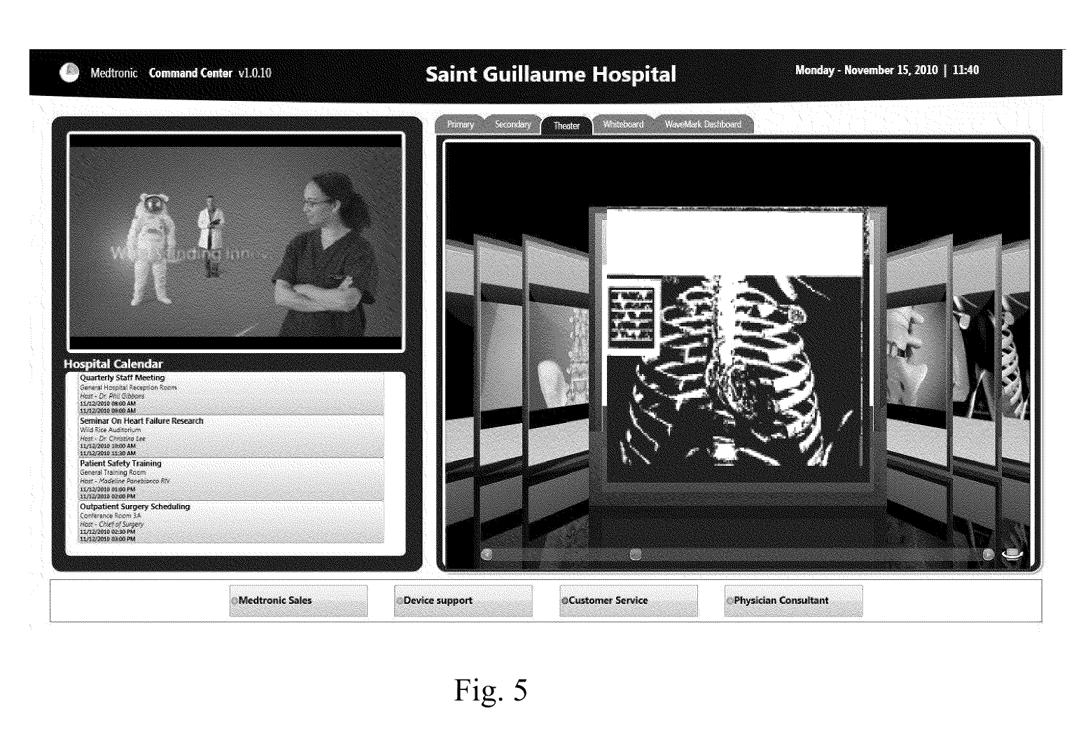

For example, FIG. 5 shows a window that displays images obtained in diagnosing a patient. The images may include images obtained from a patient records database, a X-Ray station, a MRI station 95, or other source of patient data. In the example view shown in FIG. 5, a three-dimensional rendering of a patient's X-ray may be presented to a physician. The presented view of the centralized interface may allow the user to select from among all the medical images related to one or multiple patients. FIG. 5 shows that a physician may also be able to select, for example, patient lung images obtained from a MRI station 95. The images may be presented as part of a theater view that allows physicians to view patient-specific data and to view general medical topics. For example, videos related to medical diagnosis or to performing a specific hospital procedure may be presented to a physician.

The centralized interface may also present text balloons indicating that desired information will be depicted in a sequential window. The term “click” is intended to cover both selecting an item utilizing a cursor controlled by an input device such as a mouse or scrolling wheel or similar devices, touch pads or touch screens.

The centralized interface of the command center 50 may also allow users to customize their views. For example, a user may have the option of keeping the feed of news headlines in one of the views presented by the interface. The user may also be able to specify the source of the news headlines. For example, the command center 50 may retrieve news headlines from a medical journal database, a medical news search engine, or may retrieve more general news headlines from a general search engine. In another embodiment, other multimedia, such as music or photos may be presented by the centralized interface.

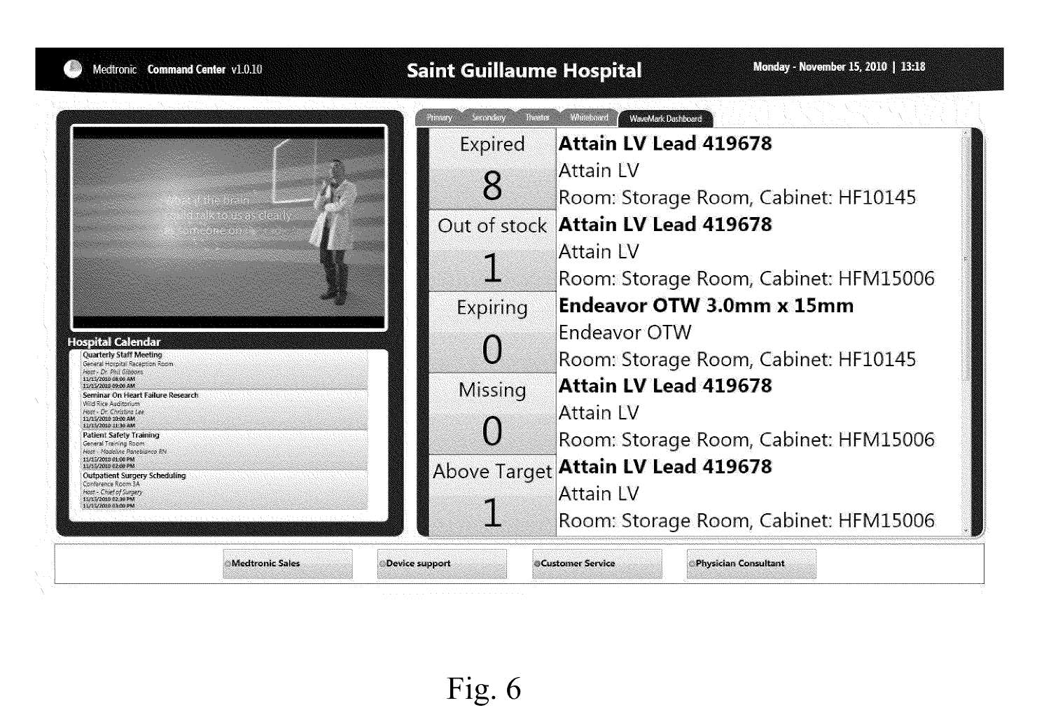

FIG. 6 shows a view of the centralized interface that may be presented to hospital administrators, nurses, and other hospital staff. The view may present the status of medical devices and supplies in the medical environment. In the example view, the centralized interface may present the location, such as a RFID shelf 92, where a device is located. The view may also present aggregate statistics, such as the number of medical devices that have expired, are out of stock, are expiring, or that are missing. The centralized interface may allow the user to input commands to the command center 50. For example, the hospital staff may input a command to deactivate expired medical devices. The medical device may be configured to deactivate itself based on the command received from the command center 50. The location of a medical device may be presented by the centralized interface, along with a floor plan of the hospital to assist personnel in locating needed medical devices. The view may also present the location of patients. The location of one or more patients may be tracked by, for example, the RFID cart 92 associated with a patient. The location of the patient may be presented by the centralized interface, along with a floor plan of the hospital to assist personnel in locating the patient. The location may be rendered by the centralized interface in the same view that shows the inventory, or in another view.

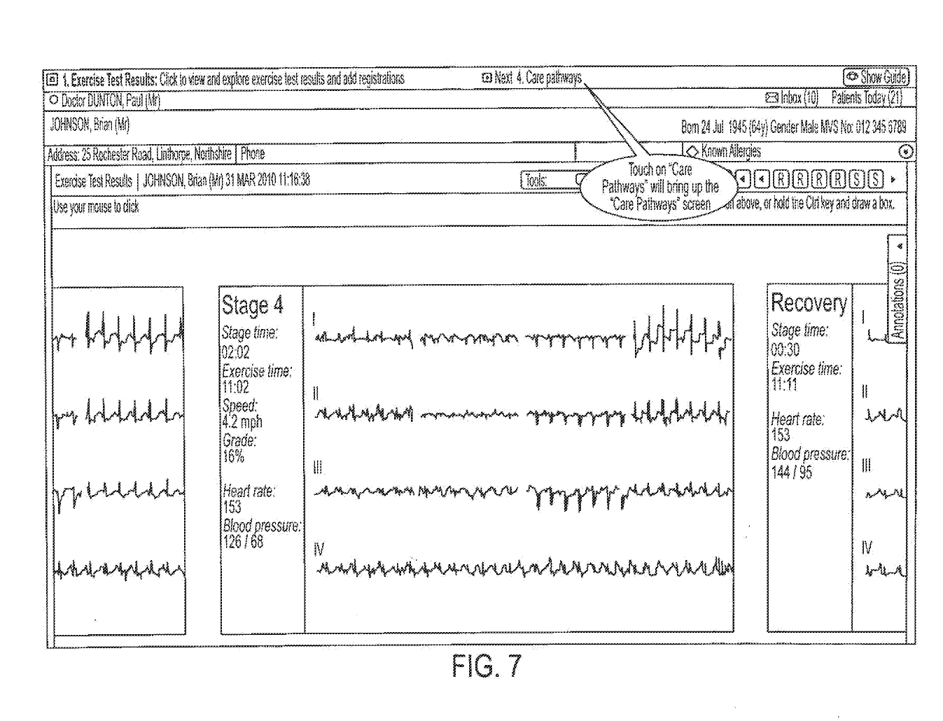

Medical data being generated by medical devices may also be presented in real time to the command center 50. For example, FIG. 7 shows an example view presented by the centralized interface of a patient's heart rate. The data may be obtained from, for example, a heart rate monitor attached to a RFID cart 92. The user may be able to switch among different monitored data for the same patient or may be able to view the same monitored data for different patients. In one example, the command center 50 may be able to aggregate data collected by different medical devices. For example, the command center 50 may aggregate data collected by a heart rate monitor, data collected by a blood pressure monitor, and data collected by a fitness assessment device and present the data in the same view. Height, weight, and other personal information may also be displayed. For example, FIG. 7 shows a patient's heart rate, blood pressure, and fitness assessment data in the same view.

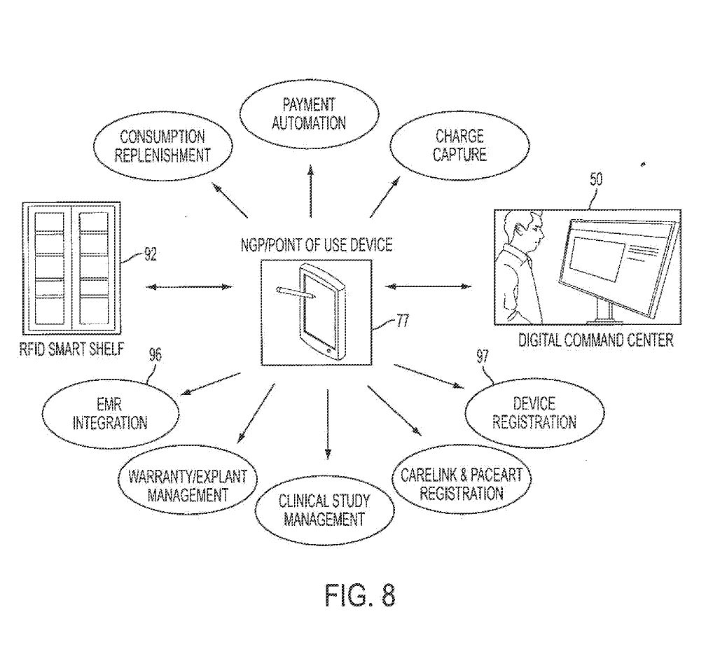

The management information presented by the centralized interface may be rendered on a dedicated terminal display located in a hospital, or may be transmitted to portable displays. For example, FIG. 8 shows a point of use device that may receive information from the digital command center 50 and display the information on the device 77. The device 77 may serve as an interface between the digital command center and other systems in the medical environment. For example, the device 77 may relay inventory management tasks between the digital command center 50 and a payment automation, charge capture, or consumption replenishment system. The device 77 may, for example, relay payment information from the command center 50 to a charge capture system, or may relay an invoice from a billing system to the command center 50. The charge capture system and billing system may be hospital subsystems related to hospital management, or may be systems provided by third parties, such as equipment suppliers or medical device manufacturers.

The device 77 may also communicate directly with various subsystems in the medical environment, such as the RFID shelf 92, RFID cart 91, MRI station 95, or ER Station 79. The device 77 may also communicate with databases that collect or archive patient data, such as CareLink®. The device 77 may directly present such information to the user. The device 77 may also relay the communicated information to the command center 50. The device 77 may also relay information from the command center 50 to medical devices on the RFID shelf 92, RFID cart 91, or in the MRI station 95 or ER Station 79.

FIG. 8 shows that the device 77 may also interface between the command center 50 and registration systems for medical devices and for patient data management. For example, the device 77 may act as an interface between the command center and a device registration system provided by the hospital or by a medical device manufacturer. For example, the device 77 may receive information related to cardiac devices and relay such information to the CareLink® program to assist in registering the device and a patient associated with the device. In another example, the device 77 may interface with the command center 50 and other hospital management systems to enroll patients in clinical study management programs. In another example, the device 77 may also interface between the command center and patient records databases, such as an EMR database that stores electronic medical records of patients.

The device 77 may also interface between the command center 50 and warranty system provided by a device supplier or medical device manufacturer. The device 77 may relay warranty claims between the command center 50 and the warranty system and may communicate warranty updates to the command center 50. Warranty claim processing may involve requesting a warranty credit, reimbursement or replacement for a medical device from the medical device manufacturer. Such requests may be prompted when a medical device is not properly working (e.g., it is broken), and/or it is defective.

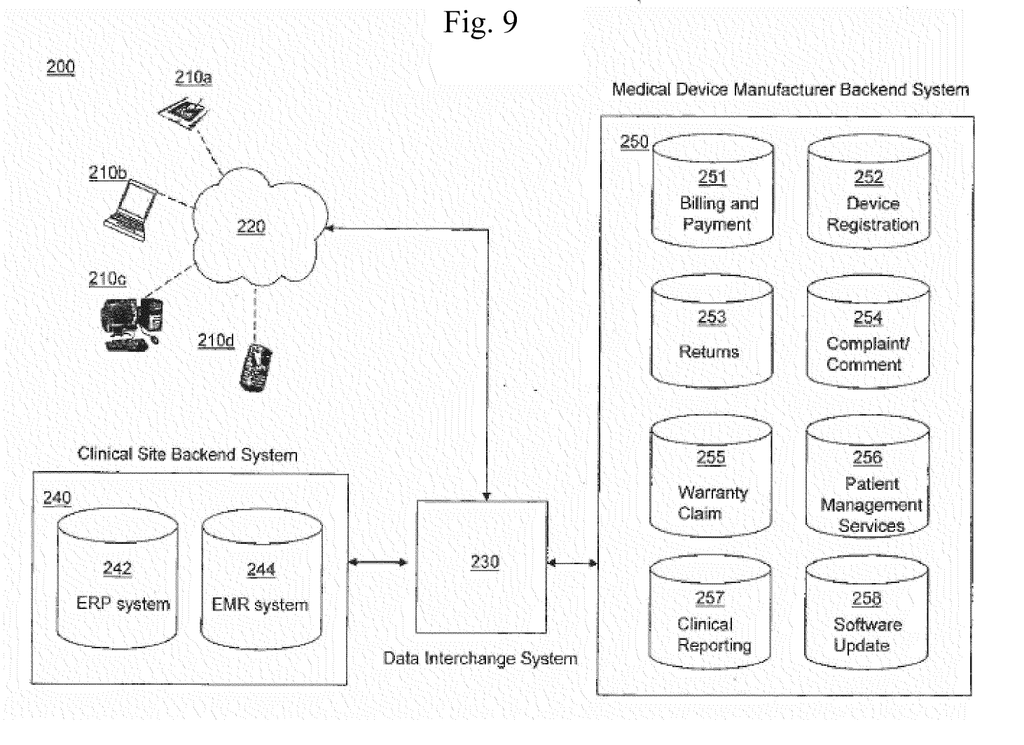

FIG. 9 shows a tablet 210a, laptop 210b, desktop 210c, or PDA 210d that may implement the device 77 and communicate with the consumption replenishment, payment automation, charge capture, device registration, and warranty systems shown in FIG. 8. The devices shown in FIG. 9 may communicate through a LAN 220 to communicate with a clinical site backend system 240 or a medical device manufacturer backend system 250. The data center 50 or the device 77 may implement a user authentication system to control access of the management tasks to selected hospital personnel. Authentication may be done by a password, an identification card, or any other authentication method.

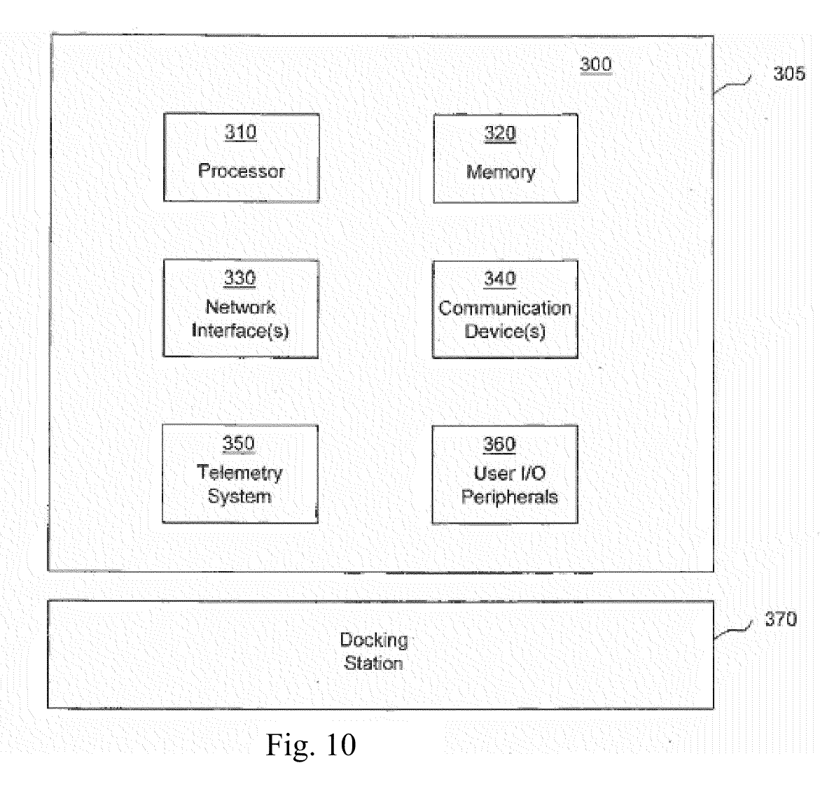

FIG. 10 illustrates an exemplary client terminal device 300 in accordance with an embodiment of the present invention.

Client terminal device 300 may include one or more modules, including, but not limited to: a processer 310, memory 320, a network interface(s) 330, communication device(s) 340, telemetry system 350, and user input/output (I/O) peripherals 360. A docking station 370 may optionally be provided. The client terminal device 300 may be removably placed in the docking station 370. One or more of the modules may be combined. For some implementations, not all modules may be necessary.

In one implementation, the client terminal device 300 may be configured as a portable, handheld device. For instance, the client terminal device 300 may be a palm-sized, tablet-sized, or notebook-sized device.

A housing 305 may be included that integrates the various modules which comprise each client terminal device 300. The housing may be constructed in or one more pieces of an impact-resistant material, such as, for example, metal, plastic, or both. One or more fasteners, such as, for example, screws, may be used to assemble the housing 305. The housing 305 may optionally include a handle for the convenience of users for holding or transporting the client terminal device 300. In some implementations, the housing 305 may include an internal chassis to modularly mount the various components. Housing may also include a power supply (not shown). This might include a plug, battery pack, transformer, AC/DC convertor, or the like, for providing power to the client terminal device 300.

The processor 310 may include one or more processing devices. For example, the processor 310 may include a dedicated module, such as, a microprocessor, central a processing unit (CPU), or an integrated circuit. In some implementations, the processor 310 may be may include hardware (such as, an application specific integrated circuit (ASIC) or field programmable gate array (FPGA)), software (firmware), or a combination of hardware and software for executing machine- or computer-implemented instructions. The processor 310 may be configured to execute an operating system and one or more applications. In some instance, the processor 310 may include a clock module for automatically generating date/time data associated with an event.

The memory 320 may be configured to store computer-readable instructions for operating the client terminal device. Such instructions may include an operating system, and one or more applications. In additional, the memory device may be configured to store other data, collected, received and/or transmitted temporarily, and/or permanently. The instructions may be configured as hardware, software (e.g., firmware), or combinations therefore. The memory 320 may include, for example, any non-volatile electronic memory device (e.g., flash memory, EEPROM, etc.) or other memory device (e.g., disk drive, writable optical disk, etc.) for storing electronic data. Memory 320 may be removable and/or couple to an interface, such as, for example, a USB port, RS-232 port, parallel or serial port, or other connector or jack, for interfacing and communicating data.

The network interface 330 may be configured to enable the client terminal device 300 to connect to, and transmit data with one or more networks. This may include one or more physical connections (e.g., jacks) for connecting to wired networks. The communication device 340 may be configured to scan and/or collect information and data from one or more sources in an automated manner. The sources may include the medical device (and/or packaging thereof), patient medical records, billing records, or other source. The communication device module 340 may include one or more devices for reading machine-readable indicia, such as, a (1D and 2D) bar-code reader, a radio-frequency identification (RFID) tag reader, magnetic strip reader, smart card reader, etc. Also, communication device module 340 may include a biometric reader (e.g., fingerprint, facial recognition, iris recognition, DNA, etc.) automated voice recognition device, scanner, camera, or other device for capturing information. One or more algorithms may be applied to captured data. This may include, for instance, optical character recognition (OCR/OCV) for converting scanned images to text, speech recognition for converting sound to text, decoding barcodes, etc. The step of capturing data with a communication device module, as used herein, may be known as a “scanning”

The telemetry system 350 may be configured to interface and/or communicate with one or more medical devices. The telemetry system 350 may transmit information to, and/or receive information from one or more medical devices. This may include wired and/or wireless communications. Different medical devices may have different means for communications. For instance, medical devices implanted inside the body, such as a pacemaker, may only be able to communicate via wireless communications. Other devices, though, may include a connection or jack for wired communications. The telemetry system 350 may be configured to exchange data from the medical device, such as to receive vital signs, and/or to transmit software or configuration instructions to the medical device. Also, the telemetry system 350 may activate or deactivate a medical device. In some instances, the telemetry system module 350 may adopt the ISO/IEEE 11073 Medical/Health Device Communication Standards.

The user I/O peripherals 360 may be one or more input and/or output devices configured to enable users to input data, and to view or retrieve data from the client terminal device 300. Input peripheral devices may include, for instance, one or more of: a keyboard, keypad, mouse, designated function buttons or switches, trackball, stylus, touch screen, touch pad, lighten, microphone, biometrics reader, scanner, bar code and other RFID readers and/or other input devices. Output peripheral devices may include, for instance, one or more of a: display device (e.g., screen or monitor), designated optical indicators (e.g., LEDs, lights, etc.), printing device, speakers, headphone jack, haptic device, projector, and/or other output devices. A single touch screen may, in some instances, be used for both inputting and outputting data.

The docking station 370 may be configured for holding the client terminal device 300. For instance, the client terminal device 300 may have placed in the docking station 370 when not being used. In some implementation, the docking station 370 may provide power and/or data interfacing. The client terminal device 300 may, for instance, be configured to be charged while placed in the docking station 370. Also, the client terminal device 300 and the docking station 370 may have one or more cooperating connectors (e.g., male and/or female jacks), which engage together to facilitate power and/or data transfers.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention.

What is claimed is:

1. A device, comprising:
an interface to a central command center system of a medical environment, wherein the device is configured to present data received from the central command center system, the data comprising information on:
one or more procedures scheduled at the medical environment;
schedule of one or more staff needed for one or more procedures; and
identity of one or more patients involved in the one or more procedures and the medical information of the one or more patients.

2. The device of claim 1, wherein the data further comprises information on electronic mail associated with a user of the central command center system.

3. The device of claim 2, wherein the data further comprises information on a news feed.

4. The device of claim 3, wherein the data is communicated to the central command center system via radio frequency tagging.

5. The device of claim 1, wherein the data further comprises information on one more supplies needed for the one or more procedures and the availability of the one or more supplies.

6. The device of claim 1, wherein the device is a portable medical device.

7. The device of claim 6, wherein the medical device is configured to be used in the medical environment.

8. The device of claim 7, wherein the medical environment comprises a hospital.

9. The device of claim 1, wherein the data is communicated to the central command center system via an electronic records database.

10. The device of claim 1, wherein the data is communicated directly with an electronic records database or communicated indirectly with the electronic records database via the central command center system.

11. A method, comprising:
receiving data at a device from a central command center system of a medical environment;
presenting the data at the device, the data comprising information on:
one or more procedures scheduled at the medical environment;
schedule of one or more staff needed for one or more procedures; and
identity of one or more patients involved in the one or more procedures and the medical information of the one or more patients.

12. The method of claim 11, wherein the data further comprises information on electronic mail associated with a user of the central command center system.

13. The method of claim 12, wherein the data further comprises information on a news feed.

14. The method of claim 13, wherein the data is communicated to the central command center system via radio frequency tagging.

15. The method of claim 11, wherein the data further comprises information on one more supplies needed for the one or more procedures and the availability of the one or more supplies.

16. The method of claim 11, wherein the device is a portable medical device.

17. The method of claim 16, wherein the medical device is configured to be used in the medical environment.

18. The method of claim 17, wherein the medical environment comprises a hospital.

19. The method of claim 11, wherein the data is communicated to the central command center system via an electronic records database.

20. The method of claim 11, wherein the data is communicated directly with an electronic records database or communicated indirectly with the electronic records database via the central command center system.
